(19) United States
(12) Patent Application Publication
(10) Pub. No.: US 2007/0025473 A1
(43) Pub. Date: Feb. 1, 2007

(54) Receiving apparatus

(75) Inventors: Masami Aizawa, Kanagawa (JP); Takashi Seki, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/492,777

(22) Filed: Jul. 26, 2006

(30) Foreign Application Priority Data
Jul. 27, 2005 (JP) 2005-217793

(51) Int. Cl. H04L 27/00; H04K 1/10

(52) U.S. Cl. 375/324; 375/260

(57) ABSTRACT

A demodulating circuit demodulates a digital broadcasting signal and transmission control information for identifying a transmission system of the digital broadcasting signal from a transmission signal. A buffer circuit holds the transmission control information for at least one frame period. A multi circuit periodically multiplexes the transmission control information demodulated by the demodulating circuit and the transmission control information held by the buffer circuit at least in units of one frame. The multiplexed transmission control information is supplied to the buffer circuit and is also supplied to a first error correction circuit. The first error correction circuit corrects errors of the transmission control information. The transmission control information is multiplexed, and accuracy of error correction is improved by a time interleaving effect so that lead-in time is reduced.

This application is based upon and claims the benefit of priority from the prior Japanese Patent Applications No. 2005-217793, filed in Japan on Jul. 27, 2005; the entire contents of which are incorporated herein by reference.

### BACKGROUND OF THE INVENTION

1. Field of the Invention

The present invention relates to a receiving apparatus suitable for receiving a digital broadcasting signal transmitted by an orthogonal frequency division multiplexing (OFDM) system.

2. Description of Related Art

In recent years, development of digital transmission of sound and video signals is actively pursued. In particular, an OFDM system is adopted as an optimal system in Europe, Japan and so on. In the OFDM system, modulation and demodulation are performed by assigning data to multiple carriers which are mutually orthogonal. An inverse fast Fourier transform (IFFT) process is performed on a transmitting side and a fast Fourier transform (FFT) process is performed on a receiving side respectively. It is possible, in a transmission system of Japan, to apply an arbitrary modulation method to the carriers. Therefore, transmission control information (hereafter, referred to as “TMCC information”) for identifying the transmission system such as the modulation method of a digital broadcasting signal is added to the digital broadcasting signal. The receiving side demodulates and decodes the TMCC information and determines the transmission system so as to demodulate and decode the digital broadcasting signal based on a determination result.

As for the digital broadcasting signal, the transmission system of Japan is strongly characterized by interleaving for a long time and is said to be a system strong in mobile reception (refer to Literature 1 (Association of Radio Industries and Businesses, “800 MHz Band OFDM Modulation Method Television Broadcast Program Material Transmission System Standard,” October, 2000, ver. 2.0) forinstance). However, nointerleaving is performed as to the TMCC information because it needs to be detected as fast as possible. As for transmission of the TMCC information, enhancement of error resilience is conventionally considered (refer to Literature 2 (The Institute of Image Information and Television Engineers, “Technical Report Vol. 23,” No. 13, p. 13 to 18) forinstance). There is also a proposed technique of averaging only values of TMCC carriers of which reception level is high as against frequency selective fading (refer to Literature 3 (Japanese Patent Laid-Open No. 2002-247003) for instance).

As for one-segment terrestrial sound broadcasting and the like, however, the number of carriers of the TMCC information is small so that an adverse effect of loss of the TMCC carriers because of being multipath is serious. Furthermore, there are many cases where all the carriers for transmitting the TMCC information disappear when time-direction fading occurs. There are also the cases where reception becomes difficult because of amplitude fluctuations due to the fading when an automobile, a train or the like is moving at high-speed. Even in such cases, the digital broadcasting signal is often in a relatively easily decodable state since it has undergone time interleaving and the like. However, the TMCC information is often difficult to decode. In the case where the TMCC information cannot be decoded, the modulation method, encoding rate and the like are unknown so that the digital broadcasting signal cannot be decoded consequently. In most cases, the same information is repeatedly transmitted as the TMCC information. Therefore, it is normally possible, by decoding once instead of decoding every frame, to perform the reception by holding the TMCC information even in a state of frequent occurrence of errors as long as the transmission system remains unchanged. However, there is a problem that it may become unreceivable for a long time because initial lead-in at power-on and the like cannot be performed.

### SUMMARY OF THE INVENTION

A receiving apparatus according to an embodiment of the present invention is the one including: a demodulating circuit for demodulating a digital broadcasting signal and transmission control information for identifying a transmission system of the digital broadcasting signal based on a transmission signal transmitted in frame; a buffer circuit for holding the transmission control information for at least one frame period; a multi circuit for periodically multiplexing the demodulated transmission control information and the transmission control information held by the buffer circuit at least in units of one frame and supplying the multiplexed transmission control information to the buffer circuit; and

a first error correction circuit for correcting errors of and decoding the multiplexed transmission control information.

### BRIEF DESCRIPTION OF THE DRAWINGS

FIG. 1 is a block diagram showing a configuration example of a receiving apparatus according to a first embodiment of the present invention;

FIG. 2 is a waveform diagram showing an example of a transmission signal received by the receiving apparatus according to the first embodiment of the present invention;

FIG. 3 is a block diagram showing a configuration example of the receiving apparatus according to a second embodiment of the present invention;

FIG. 4 is a block diagram showing a configuration example of the receiving apparatus according to a first deformed example of the second embodiment of the present invention;

FIG. 5 is a diagram showing an input-output characteristic example of a level conversion circuit according to the first deformed example of the second embodiment of the present invention;

FIG. 6 is a block diagram showing a configuration example of the receiving apparatus according to a second deformed example of the second embodiment of the present invention;

FIG. 7 is a block diagram showing a configuration example of the receiving apparatus according to a third deformed example of the second embodiment of the present invention;

FIG. 8 is a block diagram showing a configuration example of the receiving apparatus according to a fourth deformed example of the second embodiment of the present invention;

FIG. 9 is a block diagram showing a configuration example of the receiving apparatus according to a third embodiment of the present invention;

FIG. 10 is a flowchart showing an operational sequence example of the receiving apparatus according to the third embodiment of the present invention; and

FIG. 11 is a block diagram showing a configuration example of the receiving apparatus according to a deformed example of the third embodiment of the present invention.

### DETAILED DESCRIPTION OF THE INVENTION

Next, first to third embodiments of the present invention will be described with reference to the drawings. The same or similar portions are given the same or similar symbols in the descriptions of the drawings of the following first to third embodiments.

### First Embodiment

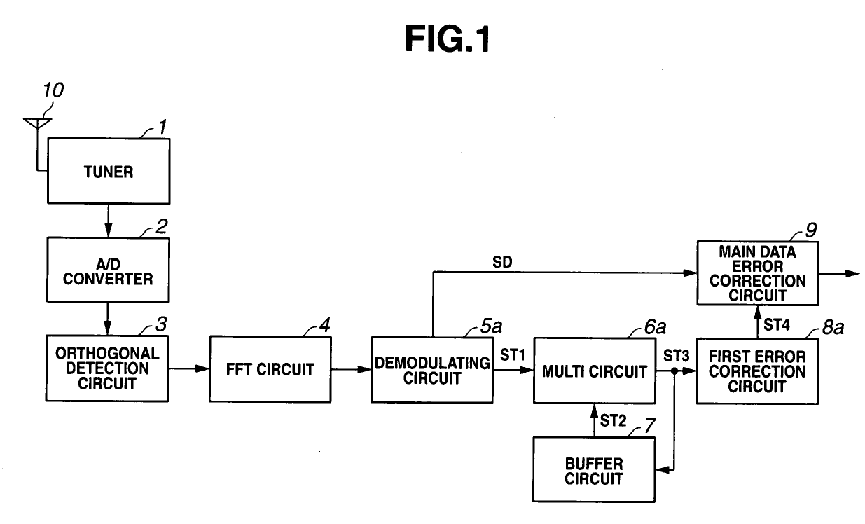

As shown in FIG. 1, a receiving apparatus according to a first embodiment of the present invention includes an antenna 10, a tuner 1, an analog-to-digital (A/D) converter 2, an orthogonal detection circuit 3, an FFT circuit 4, a demodulating circuit 5a, a multi circuit 6a, a buffer circuit 7, a first error correction circuit 8a and a main data error correction circuit 9. The demodulating circuit 5a demodulates a digital broadcasting signal SD and transmission control information ST1 for identifying a transmission system of the digital broadcasting signal SD based on a transmission signal transmitted in frame. Here, the “digital broadcasting signal” as a main data signal means a digital television broadcasting signal, a digital sound broadcasting signal or the like for instance. The “transmission control information” as additional information means the information for identifying a modulation method and an encoding rate of the digital broadcasting signal and the like for instance, where TMCC information can be used as to an OFDM transmission system of Japan.

A description will be given below by exemplifying the case of using the TMCC information as the transmission control information. The buffer circuit 7 holds TMCC information ST3 for at least one frame period. The multicircuit 6a multiplexes the TMCC information ST1 demodulated by the demodulating circuit 5a and TMCC information ST2 held by the buffer circuit 7 periodically in units of one frame, and supplies multiplexed TMCC information ST3 to the buffer circuit 7 and first error correction circuit 8a. It is possible to use a multiplexer as the multi circuit 6a. The first error correction circuit 8a corrects errors of and decodes the multiplexed TMCC information ST3. The receiving apparatus shown in FIG. 1 can receive one-segment terrestrial sound broadcasting for instance, and is implemented on a mobile communication device and the like.

Quadri-phase shift keying (QPSK), quadrature amplitude modulation (QAM) and the like are used as modulation methods of the digital broadcasting signal SD while Viterbi decoding, connected encoding of reed solomon (RS) and the like are used as encoding methods. As for the TMCC information in comparison, the same information is repeatedly transmitted in frame in a different format from the digital broadcasting signal SD. To be more precise, the TMCC information is transmitted by using a difference set cyclic code as an error-correcting system and having differential binary phase shift keying (differential BPSK) and the like used by multiple carriers.

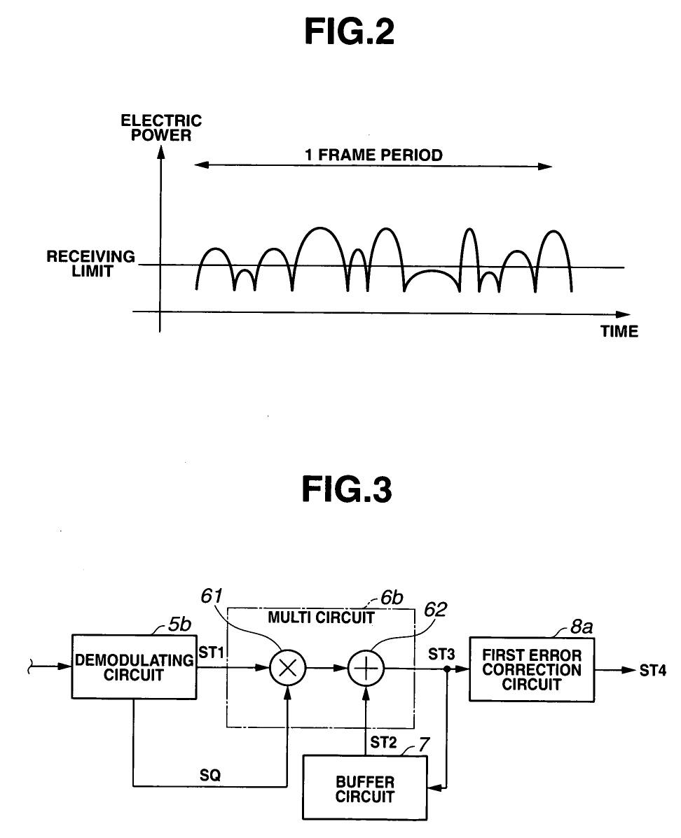

Here, FIG. 2 shows an example of a state incapable of reception (decoding). As shown in FIG. 2, if significant amplitude fluctuations exist in one frame, it is no longer possible to demodulate or decode signals below a threshold such as a portion in which the amplitude is a minimum value. The digital broadcasting signal SD performs so-called time interleaving, that is, sorting and error corrections of data among symbols in order to avoid being unable to decode it by partially exceeding correcting capability in the case where there are time fluctuations or frequency selective interruptions as a transmission condition. However, the interleaving is not adopted as to the TMCC information. Therefore, there are the cases where, even if the digital broadcasting signal SD is correctable, it can no longer be corrected when a drop of amplitude exceeds the correcting capability of the TMCC information, such as the correcting capability of the difference set cyclic code. Even if the correcting capability is extended by repeated decoding, it is not possible to handle error occurrences over that value.

Thus, the first embodiment takes advantage of the repeated transmission of the same TMCC information in frame so as to multiplex the TMCC information in units of one frame or in units of multiple frames. The TMCC information is multiplexed in units of one frame or in units of multiple frames so that reduction in lead-in time is realized by a time interleaving effect by means of multiplexing even in a situation where the reception is difficult without the time interleaving effect, such as fast fading. A description will be given below as to the case where the multi circuit 6a and buffer circuit 7 perform the process in units of one frame.

As for a radio frequency (RF) band transmission signal received by the antenna 10 shown in FIG. 1, a signal of a predetermined channel is converted to an intermediate frequency (IF) band by the tuner 1, and is converted to a digital signal by the A/D converter 2. The digital signal from the A/D converter 2 is converted to a complex base band signal by the orthogonal detection circuit 3. The FFT circuit 4 converts the transmission signal on a time base to data on a frequency scale by an FFT calculation as to the complex base band signal. The demodulating circuit 5a demodulates the transmission signal after the FFT calculation and equalizes the transmission signal after the FFT calculation so as to eliminate a strain component due to a transmission channel characteristic.

Furthermore, the demodulating circuit 5a extracts the TMCC information ST1 from a demodulated signal and supplies it to the multi circuit 6a. The buffer circuit 7 stores the TMCC information for a transmission period (one frame) for instance and holds it until a next frame. The multi circuit 6a multiplexes the TMCC information ST2 from the buffer circuit 7 and the TMCC information ST1 from the demodulating circuit 5a so as to supply them to the first error correction circuit 8a and the buffer circuit 7. The first error correction circuit 8a detects and corrects errors of the TMCC information ST3 by performing the error correction using the difference set cyclic code.

The TMCC information ST4 having undergone the error correction by the first error correction circuit 8a is supplied to the main data error correction circuit 9, and is used to determine a multiplexing mode, a modulation method, an interleave length and an encoding rate and the like of the digital broadcasting signal SD. The main data error correction circuit 9 performs a deinterleaving process and an error correction process such as the Viterbi decoding and connected encoding of reed solomon (RS) based on a determination result.

Next, a description will be given by referring to FIG. 1 as to an operation example of the receiving apparatus according to the first embodiment of the present invention.

(A) In an initial state, no TMCC information is held by the buffer circuit 7. Therefore, the TMCC information ST1 demodulated by the demodulating circuit 5a is supplied as the TMCC information ST3 to the buffer circuit 7 and the first error correction circuit 8a via the multi circuit 6a. The buffer circuit 7 holds the TMCC information ST3 in frame.

(B) If the next frame is transmitted, the multi circuit 6a multiplexes the TMCC information ST1 from the demodulating circuit 5a and the TMCC information ST2 of an immediately preceding frame outputted by the buffer circuit 7. The multiplexed TMCC information ST3 is supplied to the first error correction circuit 8a.

(C) The first error correction circuit 8a corrects errors of and decodes the TMCC information ST3 from the multi circuit 6a. The TMCC information ST4 having undergone the error correction and decoding is supplied to the main data error correction circuit 9. The main data error correction circuit 9 performs decoding of the digital broadcasting signal SD and the like based on the TMCC information ST4 having undergone the error correction and decoding.

Thus, the receiving apparatus according to the first embodiment multiplexes the TMCC information to allow the TMCC information to be decoded even in the state of frequent occurrences of errors. Therefore, it is possible, in the one-segment terrestrial sound broadcasting and the like, to have good reception performance even in the case where there is an interruption of reception such as fast fading and demodulating performance deteriorates.

In the case where the multi circuit 6a synchronously adds the TMCC information of multiple frame periods, that is, by performing multiplexing by a period which is an integral multiple of the frame period, it is possible to improve a signal-to-noise ratio (SN ratio).

### Second Embodiment

As shown in FIG. 3, the receiving apparatus according to a second embodiment of the present invention includes a multi circuit 6b having a multiplier 61 connected to a demodulating circuit 5b and an adder 62 connected to the multiplier 61 and buffer circuit 7. The multiplier 61 multiplies a received quality signal SQ indicating a received quality of the transmission signal by the TMCC information ST1 from the demodulating circuit 5a. To be more specific, the TMCC information ST1 from the demodulating circuit 5a is weighted according to the received quality of the transmission signal. The SN ratio can be used as a measure of the received quality for instance.

It is possible, by way of example, to use the transmission signal before being equalized inside the demodulating circuit 5b as the received quality signal SQ. The adder 62 adds the TMCC information outputted by the multiplier 61 to the TMCC information ST2 held by the buffer circuit 7.

It is generally thinkable that received SN is good in the case where received power is high. Therefore, weighting is performed according to the received power, and a value of a received symbol rendered multivalued-level (soft-determination) is integrated by the multi circuit 6b. As an easy method, the TMCC information ST1 itself should be added so that the amplitude becomes equivalent to the power so as to process it easily without using the received quality signal SQ.

As a method for calculating a weighting factor (received quality signal SQ), it is possible, in the case of differential detection and the like, to use a geometric average or an arithmetic average of two symbols or a larger one or a smaller one of the two symbols. It is also possible to use the SN ratio or the like separately determined by using an additional circuit for detecting the SN ratio.

Furthermore, in the case where the amplitude of the transmission signal is extremely large or extremely small, occurrences of the interruptions and distortions are expected. In this case, reliability as the signal is so low that there is a possibility of deterioration in the case of using it for multiplexing. Therefore, in the case where the amplitude of the transmission signal is larger or smaller than a set-up value, a former value is held without multiplexing it. It is also possible to render the weighting factor (received quality signal SQ) as “0” so as not to exert influence.

Next, a description will be given by referring to FIG. 3 as to an operation example of the receiving apparatus according to a second embodiment of the present invention. However, overlapping descriptions will be omitted as to the same operation as the operation example of the receiving apparatus of the first embodiment.

(A) The demodulating circuit 5b supplies the TMCC information ST1 and the received quality signal SQ to the multiplier 61.

(B) The multiplier 61 performs the weighting by multiplying the received quality signal SQ by the TMCC information ST1.

(C) The adder 62 adds the weighted TMCC information to the TMCC information ST2 held by the buffer circuit 7. The added TMCC information ST3 is supplied to the first error correction circuit 8a.

Thus, it is possible, according to the receiving apparatus of the second embodiment, to perform the multiplexing in consideration of the received quality of the transmission signal so as to multiplex the TMCC information more effectively.

### First Deformed Example of the Second Embodiment

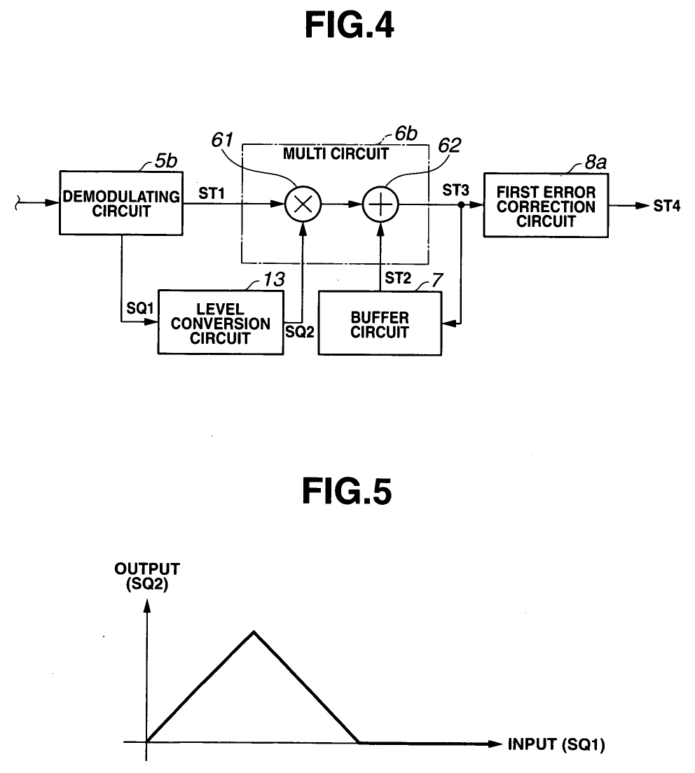

As shown in FIG. 4, the receiving apparatus according to a first deformed example of the second embodiment of the present invention may further include a level conversion circuit 13 connected between the demodulating circuit 5b and the multiplier 61. The level conversion circuit 13 converts the level of a received quality signal SQ1 from the demodulating circuit 5b.

As described above, the reliability as the signal is low in the case where the amplitude of the transmission signal is extremely large or extremely small. Therefore, as shown in FIG. 5, an output level (level of a received quality signal SQ2) is decreased as an input level is further increased or decreased from a desired level in reference to the desired level of the received quality signal SQ1 from the demodulating circuit 5b.

Therefore, the receiving apparatus according to the first deformed example of the second embodiment can perform the weighting of the TMCC information ST1 more correctly than the second embodiment.

### Second Deformed Example of the Second Embodiment

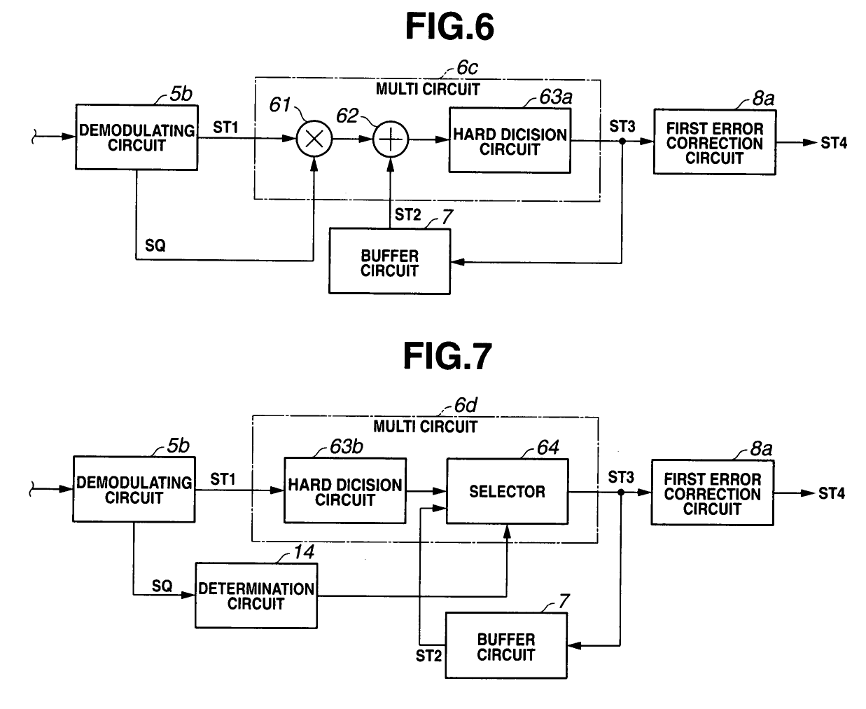

As shown in FIG. 6, the receiving apparatus according to a second deformed example of the second embodiment of the present invention may have a configuration in which a multi circuit 6c further includes a hard dicision circuit 63a connected between the adder 62 and the first error correction circuit 8a.

The hard dicision circuit 63a makes a hard dicision of the TMCC information outputted by the adder 62 and converts it to 1 bit of “10” or “1.” Consequently, a data amount of the TMCC information ST3 held by the buffer circuit 7 decreases so that a circuit scale of the buffer circuit 7 can be significantly reduced.

### Third Deformed Example of the Second Embodiment

As shown in FIG. 7, the receiving apparatus according to a third deformed example of the second embodiment of the present invention may further include a determination circuit 14 for comparing the received quality signal SQ to a fixed value and determining a received quality. Furthermore, this configuration is different from FIG. 3 in that a multi circuit 6d includes a hard dicision circuit 63b for making a hard dicision of the TMCC information ST1 and a selector 64 for selecting an output of either the hard dicision circuit 63b or the buffer circuit 7.

The selector 64 basically selects the output of the hard dicision circuit 63b, and selects the buffer circuit 7 only in the case where the determination circuit 14 determines that the received quality is insufficient. Therefore, the buffer circuit 7 holds the former value in the case where the received quality is insufficient, and the contents of the buffer circuit 7 are updated only in the case where the received quality is determined to be high.

### Fourth Deformed Example of the Second Embodiment

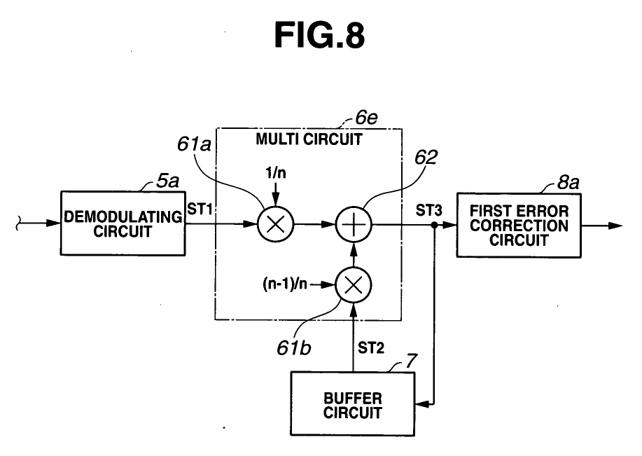

As shown in FIG. 8, the receiving apparatus according to a fourth deformed example of the second embodiment of the present invention may use arithmetic processing of infinite impulse response (IIR) as a multiplex mode. To be more precise, a multi circuit 6e includes a first multiplier 61a, a second multiplier 61b and the adder 62. The first multiplier 61a multiplies the TMCC information ST1 from the demodulating circuit 5a by a first coefficient 1/n (0<n). The second multiplier 61b multiplies the TMCC information ST2 held by the buffer circuit 7 by a second coefficient (n−1)/n. The adder 62 adds the outputs of the first and second multipliers 61a and 61b.

Here, if the TMCC information ST1 from the demodulating circuit 5a is Tin, the TMCC information ST2 held by the buffer circuit 7 is D (t−1), and the TMCC information ST3 outputted by the multi circuit 6e is D (t), the following formula holds.
D(t)=D(t−1)*(n−1)/n+Tin/n (1)

In the case of performing the multiplexing (integration) in units of multiple frames, TMCC determination takes a long time. Thus, it is possible to correct the TMCC for each of the frames by performing the process of IIR shown in the formula (1) instead of simply performing synchronous addition.

### Third Embodiment

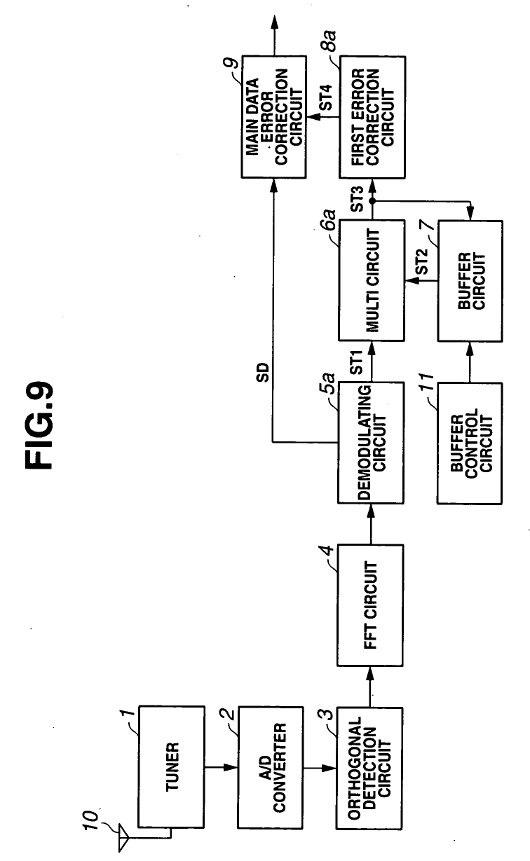

As shown in FIG. 9, the receiving apparatus according to a third embodiment of the present invention is different from FIG. 1 in that it includes a buffer control circuit 11 for controlling the buffer circuit 7. The buffer control circuit 11 monitors the demodulating circuit 5a for instance, and stops the operation of the buffer circuit 7 until the operation of the demodulating circuit 5a gets in a steady state. In a first processing step, the TMCC information is not held by the buffer circuit 7 and its state of holding is indefinite. Therefore, the multiplexing is not performed by the multi circuit 6a, and the demodulated TMCC information ST1 is transmitted as-is to the first error correction circuit 8a and the buffer circuit 7.

The A/D converter 2, orthogonal detection circuit 3, FFT circuit 4, demodulating circuit 5a and the like have the transmission signals transmitted in a frame structure, and so lead-in time in frame is necessary. Furthermore, there is an error between an oscillating frequency and a transmit frequency of a local oscillator inside the tuner 1. For this reason, a clock is regenerated from the transmission signal in the orthogonal detection circuit 3, demodulating circuit 5a and the like.

Thus, if the buffer circuit 7 is operated before completing synchronous processing such as a frame synchronization state and clock regeneration, the data on failures is held and performance is deteriorated. Therefore, the buffer control circuit 11 puts the buffer circuit 7 in an initialized state until the synchronous processing is completed and the state is determined to be good. If the synchronous processing is completed and the state is determined to be good, the multiplexing is performed by the multi circuit 6a until synchronization is determined to be no longer kept.

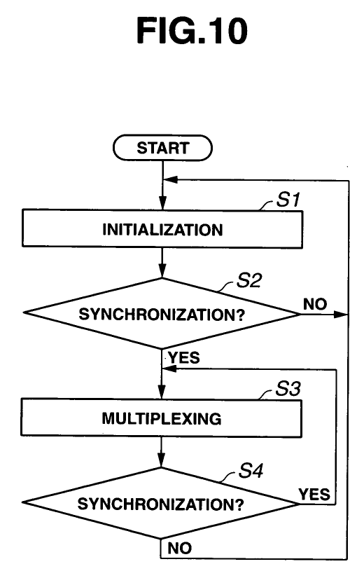

Next, a description will be given by referring to a flowchart of FIG. 10 as to an operation example of the receiving apparatus according to the third embodiment of the present invention. However, overlapping descriptions will be omitted as to the same operation as the operation example of the receiving apparatus of the first embodiment.

(A) In a step S1, the buffer control circuit 11 initializes the buffer circuit 7. If the buffer circuit 7 is initialized, it moves on to a step S2.

(B) In the step S2, the buffer control circuit 11 determines whether or not the synchronous processing such as the frame synchronization state and clock regeneration is completed. If determined that the synchronous processing is completed, it moves on to a step S3. If determined that the synchronous processing is not completed, it returns to the step S1.

(C) In the step S3, the multi circuit 6a starts the multiplexing. Once the multiplexing is started, it moves on to a step S4.

(D) In the step S4, the buffer control circuit 11 determines whether or not the synchronization such as the frame synchronization state and clock regeneration is kept. If determined that the synchronous processing is kept, it returns to the step S3. If determined that the synchronization is not kept, the process returns to the step S1.

Thus, the receiving apparatus according to the third embodiment does not operate the buffer circuit 7 until the synchronous processing such as the frame synchronization state and clock regeneration is completed. Therefore, it is possible to avoid the situation where the data on failures is held and the performance is deteriorated.

The above-mentioned operation example of the receiving apparatus according to the third embodiment describes an example in which the buffer control circuit 11 initializes the buffer circuit 7 in the step S1. In the case of using the multi circuit 6b shown in FIG. 3, however, it is also possible to exert control to render the weighting factor (received quality signal SQ) as “0” so as not to have the TMCC information inputted to the buffer circuit 7.

### Deformed Example of the Third Embodiment

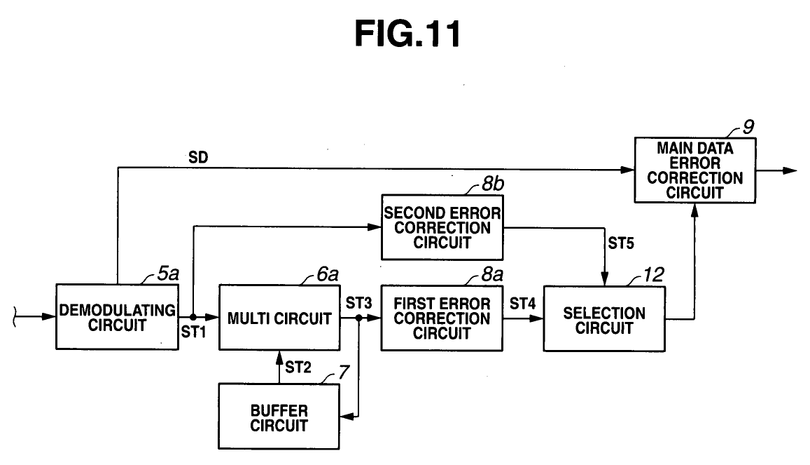

As shown in FIG. 11, the receiving apparatus according to a deformed example of the third embodiment of the present invention may further include a second error correction circuit 8b connected to the demodulating circuit 5a and a selection circuit 12 connected between the outputs of the first and second error correction circuits 8a and 8b and the main data error correction circuit 9.

As with the above-mentioned third embodiment, there are the cases where, even if sequential processing is implemented, errors in synchronous determination occur and bad data is multiplexed and remains during TMCC multiplexing so that the entire performance is deteriorated to an uncorrectable extent.

Thus, as shown in FIG. 11, the second error correction circuit 8b corrects errors of only the demodulated TMCC information ST1 in parallel with the multiplexing. The selection circuit 12 compares an error correction result of the first error correction circuit 8a with an error correction result of the second error correction circuit 8b so as to select the TMCC information decoded without an error, that is, decoded first.

It is consequently possible to avoid a problem by adopting the error correction result of the first error correction circuit 8a in the cases where the errors in synchronous determination occur and the bad data is multiplexed and remains during the TMCC multiplexing.

FIG. 11 shows an example including two systems of the error correction circuits 8a and 8b. However, it is also possible to share one error correction circuit by time-sharing.

### Other Embodiments

As above, the present invention is described according to the first to third embodiments. However, the dissertations and drawings forming a part of this disclosure should not be interpreted as limiting the present invention. Those skilled in the art may clarify various alternative embodiments, working examples and technologies from this disclosure.

Furthermore, an example of using the TMCC information as the transmission control information is described. However, it is possible to use any additional information for repeatedly transmitting the same information in frame instead of the TMCC information.

The receiving apparatuses according to the first to third embodiments already mentioned may be configured as semiconductor integrated circuits respectively. In FIG. 1, it is possible, by way of example, to monolithically integrate a part of the tuner 1 and the A/D converter 2, orthogonal detection circuit 3, FFT circuit 4, demodulating circuit 5a, multi circuit 6a, buffer circuit 7, first error correction circuit 8a and main data error correction circuit 9 on the same semiconductor chip.

It is possible to independently implement each of the above-mentioned first embodiment, the second embodiment, the first deformed example of the second embodiment, the second deformed example of the second embodiment, the third deformed example of the second embodiment, the fourth deformed example of the second embodiment, the third embodiment and the deformed example of the third embodiment. However, they may also be implemented in combination respectively.

Thus, it should be understood that the present invention includes various embodiments and the like not described herein. Therefore, the present invention is only limited by invention-specific matters of reasonable claims from this disclosure.

What is claimed is:

1. A receiving apparatus comprising:
a demodulating circuit for demodulating a digital broadcasting signal and transmission control information for identifying a transmission system of the digital broadcasting signal based on a transmission signal transmitted in frame;
a buffer circuit for holding the transmission control information for at least one frame period;
a multi circuit for periodically multiplexing the demodulated transmission control information and the transmission control information held by the buffer circuit at least in units of one frame and supplying the multiplexed transmission control information to the buffer circuit; and
a first error correction circuit for correcting errors of and decoding the multiplexed transmission control information.

2. The receiving apparatus according to claim 1, wherein the multicircuit weights the demodulated transmission control information based on information on a transmission quality of the transmission signal and then multiplexes the information.

3. The receiving apparatus according to claim 2, wherein the multi circuit uses SN of the transmission signal as the information on the transmission quality.

4. The receiving apparatus according to claim 2, wherein the multi circuit uses the transmission signal before an equalizing process in the demodulating circuit as the information on the transmission quality.

5. The receiving apparatus according to claim 2, wherein the multi circuit uses received power as the information on the transmission quality.

6. The receiving apparatus according to claim 2, wherein the multi circuit uses a result of addition of the demodulated transmission control information as the information on the transmission quality.

7. The receiving apparatus according to claim 2, wherein, in the case of demodulating the transmission control information by differential detection in the demodulating circuit, the multi circuit uses a geometric average or an arithmetic average of two symbols or one of the two symbols used for the differential detection as the information on the transmission quality.

8. The receiving apparatus according to claim 2, wherein the multi circuit omits the multiplexing in the case where the information on the transmission quality of the transmission signal indicates that the transmission quality of the transmission signal is lower than a predetermined threshold.

9. The receiving apparatus according to claim 8, wherein the multi circuit realizes omission of the multiplexing by rendering a weighting factor based on the information on the transmission quality as 0.

10. The receiving apparatus according to claim 2, wherein the multi circuit renders the weighting based on the information on the transmission quality nonlinear in the case where the information on the transmission quality of the transmission signal indicates that the transmission quality of the transmission signal is lower than a predetermined first threshold or higher than a predetermined second threshold.

11. The receiving apparatus according to claim 2, comprising:
a determination circuit for determining whether or not the transmission quality of the transmission signal is higher than a predetermined threshold according to information on the transmission quality of the transmission signal; and
a buffer control circuit for, given a determination result of the determination circuit, updating the transmission control information of the buffer circuit in the case where the transmission quality of the transmission signal is higher than the predetermined threshold and causing the buffer circuit to hold a former value of the transmission control information in the case where the transmission quality of the transmission signal is the predetermined threshold or lower.

12. The receiving apparatus according to claim 2, wherein the multi circuit multiplexes a result of making a hard dicision of the transmission control information after the weighting.

13. The receiving apparatus according to claim 2, wherein the multi circuit uses arithmetic processing of infinite impulse response for the multiplexing.

14. The receiving apparatus according to claim 1, wherein the multi circuit makes a soft determination of the demodulated transmission control information at a multivalued level and then integrates it so as to implement the multiplexing.

15. The receiving apparatus according to claim 1, wherein the multi circuit includes:
a multiplier for multiplying a received quality signal indicating a received quality of the transmission signal by the demodulated transmission control information;
an adder for adding the multiplied transmission control information to the transmission control information held by the buffer circuit; and
a hard dicision circuit for making a hard dicision of the added transmission control information.

16. The receiving apparatus according to claim 1, wherein the multi circuit includes:
a first multiplier for multiplying the demodulated transmission control information by a first coefficient;
a second multiplier for multiplying the transmission control information held by the buffer circuit by a second coefficient of which sum with the first coefficient is a fixed value; and
an adder for adding outputs of the first and second multipliers.

17. The receiving apparatus according to claim 1, further comprising:
a buffer control circuit for stopping operation of the buffer circuit until the operation of the demodulating circuit gets in a steady state.

18. The receiving apparatus according to claim 17, wherein the buffer control circuit determines the steady state by completion of synchronous processing in the demodulating circuit.

19. The receiving apparatus according to claim 1, further comprising:
a second error correction circuit for correcting errors of and decoding the demodulated transmission control information; and
a selection circuit for selecting the transmission control information decoded first out of the outputs of the first and second error correction circuits.

20. The receiving apparatus according to claim 19, including one error correction circuit for performing processing of the first and second error correction circuits by time-sharing instead of the first and second error correction circuits.
